(19) United States
(12) Patent Application Publication
(10) Pub. No.: US 2002/0065771 A1
(43) Pub. Date: May 30, 2002

(54) System and method for merchant provided pre-printed checks

(75) Inventor: Rabindranath Dutta, Austin, TX (US)

Correspondence Address: Joseph T. Van Leeuwen, P.O. Box 81641, Austin, TX, 78708-1641, US

(73) Assignee: International Business Machines Corporation

(21) Appl. No.: 09/726,270

(22) Filed: Nov. 30, 2000

(51) Int. Cl. G06F 17/60

(52) U.S. Cl. 705/40; 705/42

(57) ABSTRACT

A system and method for providing preprinted checks to customers. A customer signs up for preprinted checks with a merchant by providing the merchant with the customer's bank account information. The merchant stores the bank account information. In subsequent billing cycles, the merchant uses the customer's bank account information to prepare preprinted checks drawn off of the customer's bank account. The preprinted checks include the merchant as the payee and the current outstanding customer balance with the merchant as the amount to pay. The preprinted checks are mailed to the customer along with the customer's latest bill. The customer signs the preprinted check and returns the signed check to the merchant for processing. In one embodiment, the customer's account number with the merchant is printed in a memo area of the check in a barcode format for enhanced check processing by the merchant.

### BACKGROUND OF THE INVENTION

1. Technical Field

The present invention relates in general to a method and system for merchants to provide preprinted checks to customers.

2. Description of the Related Art

One of the most common business operations is billing customers for products or services and processing the responsive checks sent by customers. This task is manually intensive, both on the part of the merchant and on the part of customers.

Merchants typically maintain database files containing the customers' accounts. At the end of a billing cycle, often at the end of the month, the merchant processes these accounts using billing software. If a customer has a positive balance (i.e., the customer owes money), then a bill is created and mailed to the customer. Bills often have two or more parts. One part details the customer's account so that the customer is informed of the current charges. A second part, often removable from the first part via perforations, contains a summary of the customer's account, account number, and current outstanding balance. The customer returns the second part along with a check drawn off the customer's bank account to the merchant. The customer often returns the second part and the check in an envelope supplied by the merchant. These envelopes often have small windows through which the merchant's return address, printed on the second part, is viewable.

The customer typically receives a variety of bills from a number of merchants and service companies. Keeping track of bills and writing out the corresponding checks is often an unpleasant task. Some customers pay bills late because of the hassle involved with preparing checks and returning the payment. Customers also make mistakes when writing checks, for example transposing digits and sending the check to the wrong merchant. Merchants often ask that customers write their account numbers on checks, this too is often neglected by customers writing checks.

Merchants receiving checks from customers face a variety of challenges. As mentioned before, the checks prepared by the customers may contain any number of errors. The checks are often manually inspected to make sure the check has been properly prepared by the customer. If errors are found, a corrective procedure is often initiated, such as contacting the customer and notifying the customer of the error. Customers' handwriting is often difficult to decipher by the merchant's employees assigned to the task. When a customer fails to write his or her account number on the check (and the check is separated from the second part of the bill), a manual database search must often be performed to identify the customer. Since many names are common, a mistake may be made crediting the check to the wrong account.

Another approach to paying bills is to set up an automatic withdrawal between the customer and the merchant. At the end of a billing cycle, the merchant, who has been pre-approved to withdraw funds from the customer's bank account, simply withdraws the money electronically. This approach also faces challenges. First, customers are often resistant to allow a merchant to simply withdraw funds from the customer's bank account. This is especially true when the amount of the customer's bill varies from one billing cycle to the next. Second, it is more difficult for the customer to dispute charges from a merchant when the merchant has already withdrawn the disputed amount from the customer's bank account.

Late payment of bills and mistakes in customers' checks causes greater expenses, and consequently reduces merchants' profits. What is needed, therefore, is a system and method of providing the customer with preprinted checks drawn off the customer's own bank account. What is further needed is a way to make the customer's task of preparing checks simple in order to encourage the customer to return payment on a timely basis. Finally, what is needed is an identification of the user's account on the face of the check.

### SUMMARY

It has been discovered that a preprinted check can be prepared to be drawn off the customer's bank account. The preprinted check has the correct amount printed in the amount field and has an identification of the customer's account in a memo field. In one embodiment, the customer's account is printed as a barcode so that the check, when signed and returned by the customer, can be scanned and entered into the merchant's system. In the “pay to the order of” field on the check, the merchant's name and billing address may appear so that the check may be returned in an envelope with a window.

The customer signs up for a preprinted check service with a merchant by providing the merchant with information about the customer's bank account (i.e., account number, bank routing number, etc.). This information can be provided using a check or voided check. The merchant uses the information in order to prepare preprinted check for subsequent billing cycles. In subsequent billing cycles, the customer receives his or her bill along with the preprinted check. To complete the billing process, the customer only needs to sign the check and return it in an envelope. Preferably, the check is returned in an envelope supplied by the merchant. The supplied envelope may include the merchant's name and address on the front of the envelope or may have a window through which the merchant's address, printed on the check or bill, appears.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings. The use of the same reference symbols in different drawings indicates similar or identical items.

FIG. 1 is an illustration of a bill with an automatic check authorization form;

FIG. 2 is an illustration of a bill including a preprinted check;

FIG. 3 is a diagram of the interaction between a customer and a merchant to establish preprinted check delivery;

FIG. 4 is a flowchart showing the processing of a user's request for preprinted checks;

FIG. 5 is a flowchart showing the improved billing process using preprinted checks; and

FIG. 6 is a block diagram of an information handling system capable of implementing the present invention.

### DETAILED DESCRIPTION

The following is intended to provide a detailed description of an example of the invention and should not be taken to be limiting of the invention itself. Rather, any number of variations may fall within the scope of the invention which is defined in the claims following the description.

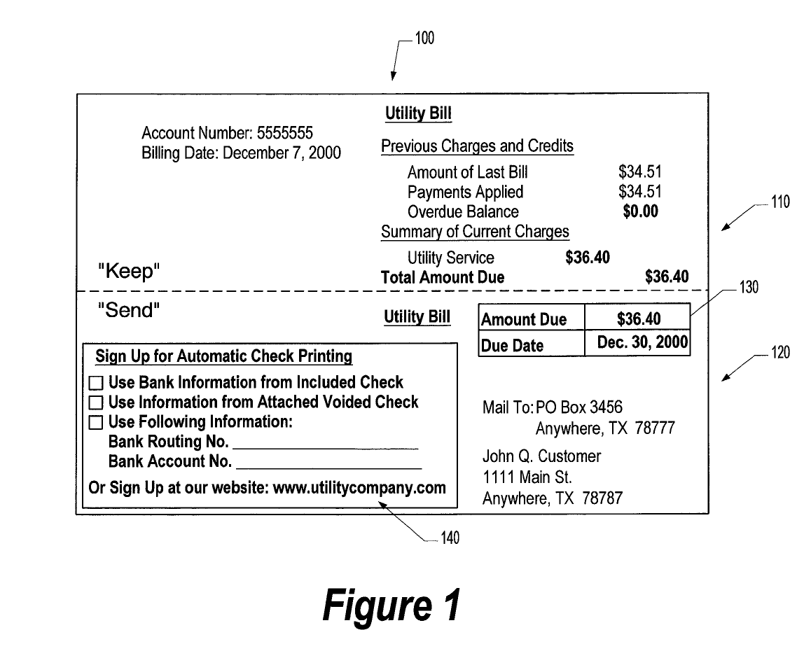

FIG. 1 shows an illustration of a bill with an automatic check authorization form. Bill 100 includes top portion 110 and bottom portion 120 which are separated by a perforation between the two portions. Other pages may be included if further detail is needed or the account information is lengthy. Top portion 110 is retained by the customer in the customers records, while bottom portion 120 is returned to the merchant, often in a merchant-supplied envelope. Bottom portion 120 includes account summary information 130 that describes the current amount due from the customer and the due date. Bottom portion 120 also includes automatic check authorization form 140.

Automatic check authorization form 140 includes options for the customer to use in order to receive preprinted checks. The first option, “Use Bank Information from Included Check,” informs the merchant to use the account number and bank routing number included on the check the customer has included in response to the current bill. The second option, “Use Information from Attached Voided Check,” indicates that the customer is attaching a separate voided check, perhaps from a different bank account, from which the bank routing number and account information should be gathered. The third option, “Use Following Information,” provides an area for the customer to fill in the bank routing number and bank account number to be used in automatic checks. Finally, an Internet web site address is given to allow the customer to sign up for automatic check delivery using the company's web site, preferably a secured web site (i.e., using Secure Socket Layers (SSL) technology or other encryption technology to keep the customer's bank account information private).

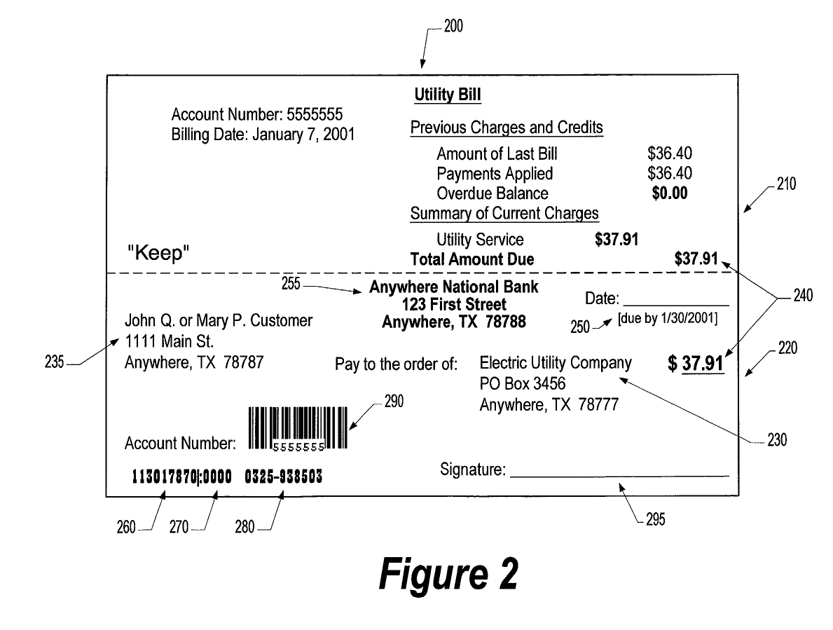

FIG. 2 shows an illustration of bill 200 including a preprinted check. After the customer signs up for automatic check delivery (i.e., using automatic check authorization form 140 shown in FIG. 1), the merchant prepares the customer's bill, or invoice, and includes a preprinted check for the customer to sign and return to the merchant. Bill 200 includes top portion 210 which is substantially similar to top portion 110 shown in FIG. 1. Top portion 210 includes a summary of the customer's current charges. Additional detail sheets may be provided if a more detailed description of charges is needed.

Preprinted check 220 is included with bill 210. Preprinted check 220 can be included with a traditional bottom bill portion (see bottom portion 120 in FIG. 1), or can include sufficient information (i.e., the customer's account information), so that preprinted check 220 can be returned to the merchant without the need for additional forms. Preprinted check 220 includes pay to the order field 230. Pay to the order field 230 includes the merchant's name for cashing or depositing the check. In the example shown, merchant address information is included with pay to the order field to allow the use of a merchant supplied envelope with a window through which the merchant's name and address appears for mailing purposes. In this manner, a large company with several bill processing centers can include a different mailing address for different groups of customers. For example, customers located in California may send their payments to one processing center whereas customers in New York may send their payments to a different processing center. The address for each customer's processing center can simply be printed below the company name in pay to order field 230 so that it appears in the envelope window.

The customer's name, as it appears on the check, voided check, or customer information provided to the merchant in FIG. 1, is shown in account holder field 235. Amount currently due 240 is shown both on top portion 210 and in the amount field on the check. Because the merchant generates both top portion 210 and preprinted check 220, typographical or transpositional errors are substantially eliminated. An additional amount line on the check stating that “Thirty Seven Dollars and 91/100”, is due may be provided as is common on many personal checks. Date due 250 is provided to inform the customer when the check is due at the merchant. This information can also be provided on top portion 210 so that the customer is clearly aware of when payment is due.

The bank information appearing on preprinted check 220 includes bank name and address 255. Other bank information includes bank routing number 260, used to identify the bank within the banking system. Sequence number 270 (shown as “0000” in FIG. 2), is provided in the event that the merchant provides sequenced preprinted checks for the customers' convenience in organizing and keeping track of their checking accounts. For example, the customer could request that a particular merchant's preprinted checks always be the same number (i.e., “8888”) or begin with a certain number and increment sequentially from that point (i.e., 8000, 8001, 8002, etc.). Sequence numbers are not required on most checks, however, so the information can be left off the check to reduce the amount of overhead and processing required to prepare preprinted checks. Account number 280 is the customer's account number at his or her bank. Oftentimes, bank routing number 260, sequence number 270, and bank account number 280 are printed using a magnetic printing process that allows checks to be processed by the bank automatically rather than manually. The process for preparing preprinted check 220 preferably includes printing this information using a magnetic printing process.

To facilitate automated processing by the merchant, preprinted check 220 includes the customer's account number in memo field 290. As shown, the account number printed in memo field 290 is printed in barcode format. In this manner, when preprinted check 220 has been signed by the customer and received by the merchant it can simply be scanned using a barcode reader. Other information, such as the amount of the check, can also be included in the barcode information so that the amount scanned can be compared with the amount of the check (i.e., $37.91), to ensure that preprinted check 220 was not tampered with before being received by the merchant.

When the customer receives preprinted check 220, he or she simply reviews the account information and amount due for this billing cycle, signs preprinted check 220 in signature field 295, fills in the date field, and mails the check back to the merchant. As stated previously, an additional bottom form (as shown in FIG. 1) may be provided and sent by the customer back to the merchant. Using a separate form in addition to preprinted check 220 facilitates the customer bypassing the preprinted check and writing out a different check for a different amount (i.e., in the event of an error on the bill or a billing dispute). This may be preferred in areas where billing disputes are more common (i.e., a credit card bill). In situations where billing disputes seldom occur, preprinted check 220 may be the only thing the customer returns to the merchant. Not having to keep track of multiple pieces of paper streamlines the bill collection process for these types of merchants.

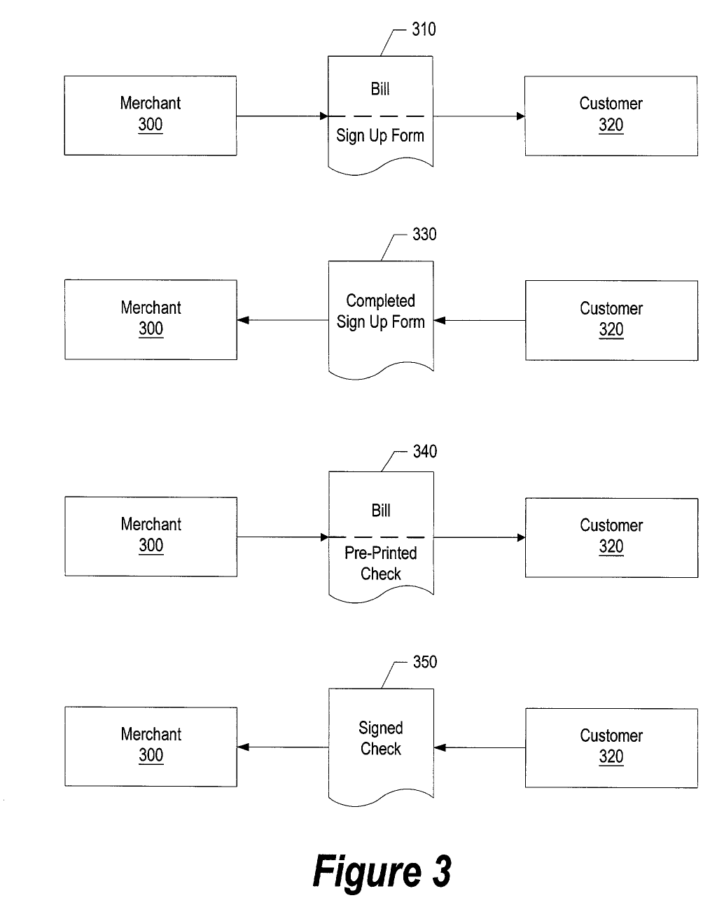

FIG. 3 shows the steps taken between a customer and a merchant to establish preprinted check delivery. Merchant 300 delivers bill/signup form 310 to customer 320. The bill is typically a traditional bill that the customer satisfies with a personal check. Attached or included with bill/signup form 310 is a form that customer can use to sign up for preprinted check delivery (see FIG. 1 for an example of bill/signup form 310). If customer 320 is interested in receiving preprinted checks, he or she responds by completing the sign up form and sending completed sign up form 330 back to merchant 300. Merchant 300 uses the account information provided by customer 320 to prepare preprinted checks. During a subsequent billing cycle, merchant 300 provides bill/preprinted check 340 to customer 340 (see FIG. 3 for an example of bill/preprinted check 340). Customer 320 reviews the bill and, if satisfied, signs the preprinted check. Customer 320 then returns signed preprinted check 350 to merchant 300 for processing and crediting of the customer's account with the merchant.

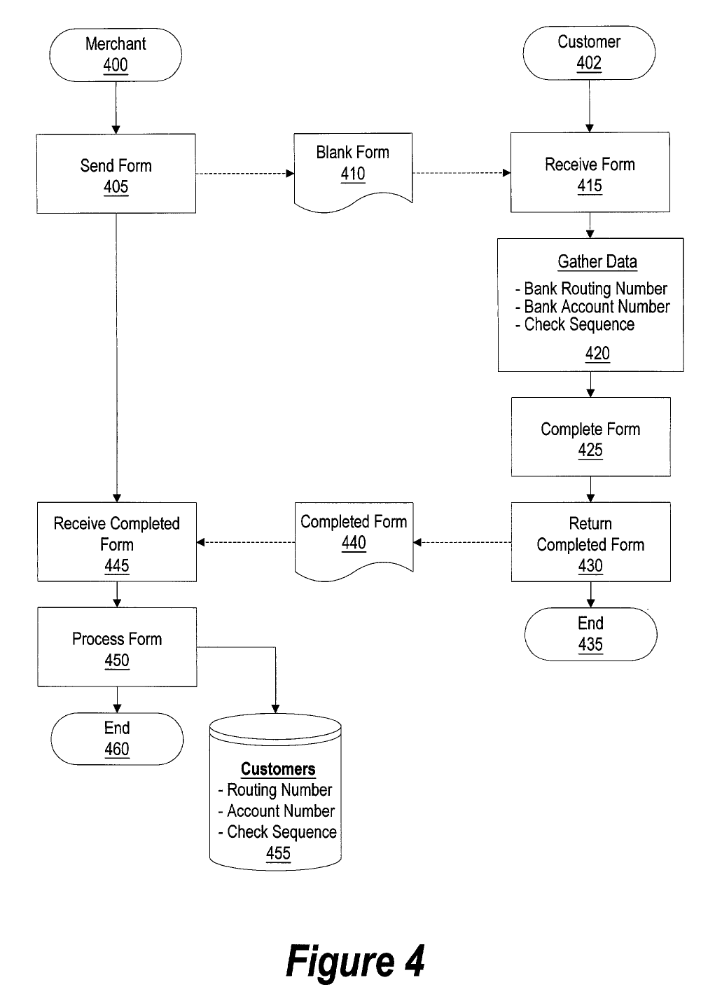

FIG. 4 shows a flowchart for processing a user's request for preprinted checks. Merchant processing commences at 400 whereupon a form is sent to the customer for preparing preprinted checks (step 405). Blank form 410 may be included with the merchant's latest bill, mailed to the customer separately, or handled electronically (i.e., using the merchant's secured web site). Customer processing commences at 402 whereupon the customer receives the blank form (step 415). The customer then gathers the information needed to complete the form (step 420). This information can be gathered by sending the merchant a check or voided check from which the information is to be used or by having the user enter the information, such as the bank routing number and checking account number, on the form. After the information has been gathered, the user completes the form (step 425) by attaching a check or voided check or by filling in the appropriate fields on the blank form. The customer then returns the completed form to the merchant (step 430). The customer may return the completed form with the customer's latest payment, mail the form separately from the customer's payment, or send the form electronically (i.e., by using the merchant's online form system or by sending the information to the merchant using email). After the customer has returned the completed form, customer processing ends at end 435. Completed form 440 is received by the merchant (step 445). The information provided by the customer is checked and processed (step 450). Form processing includes capturing the user's account information and storing the information in customer data store 455. After the information has been captured, merchant processing ends at end 460.

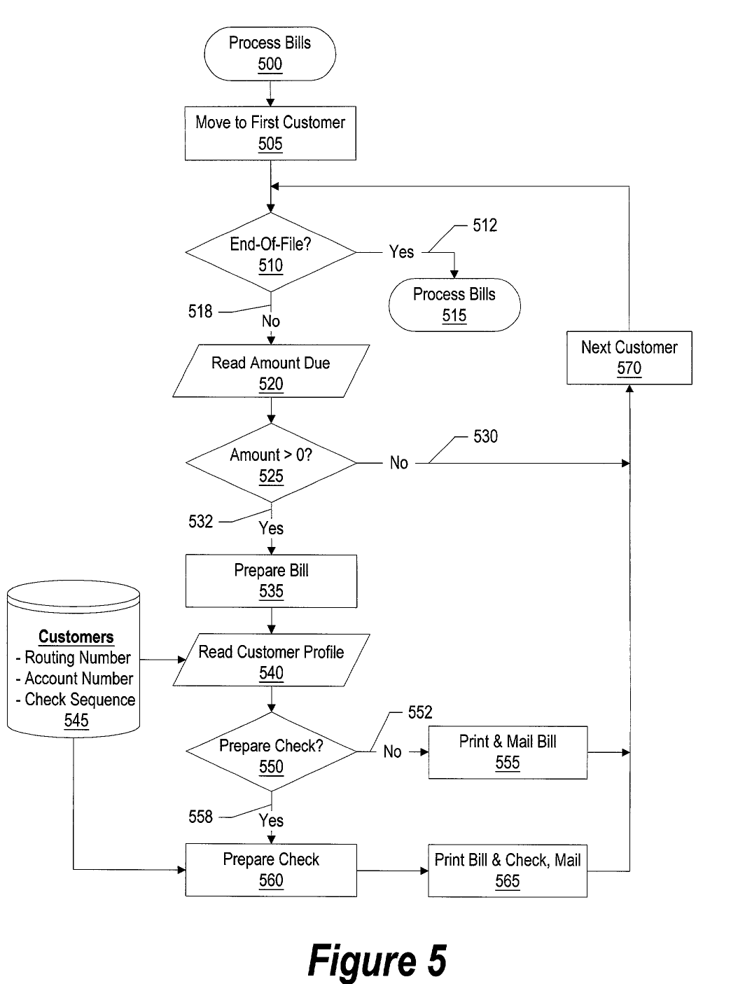

FIG. 5 shows a flowchart for improving the billing process using preprinted checks. Processing commences at 500 whereupon processing moves to the first customer in the merchant's data store (step 505, i.e., a database). A check is made to ensure that the end of file on the database table or data file has not been reached (decision 510). When the end of file has been reached, decision 510 branches to “yes” branch 512 and processing ends at 515. On the other hand, if the end of file has not been reached (as should be the case with the first customer), decision 510 branches to “no” branch 518. The customer's account is accessed and the current amount owed by the customer is read (input 520). A decision is made whether to send the customer a bill (decision 525). This decision may be if the customer's balance is less than or equal to zero, no bill is sent. Other decision criteria to determine whether a bill should be sent can be used as necessary by the merchant. If no bill should be sent to the merchant, decision 525 branches to “no” branch 530 whereupon a move next operation is performed to process the next customer (step 570) which loops back to the end of file decision 510.

If a bill should be sent, decision 525 branches to “yes” branch 532. A bill is prepared for the customer (step 535) using the customer's current charges to prepare a detailed bill. The customer's profile is read (input 540) to determine how the bill should be sent (i.e., traditional bill or preprinted check). Customer profile 545 includes the customer's bank account information used to prepare preprinted checks if the customer has signed up for the preprinted check option.

The profile information determines whether the merchant should prepare a preprinted check for the customer (decision 550). If a preprinted check has not been requested, “no” branch 552 is taken an a traditional bill is printed and mailed to the customer (step 555) before processing moves to the next customer (step 570). On the other hand, if the customer has requested preprinted checks, decision 550 branches to “yes” branch 558 whereupon the customer prepares a preprinted check (step 560) using the customer's bank account information previously supplied by the customer. The preprinted check and bill are printed and mailed to the customer (step 565) before the system processes the next customer (step 570). This processing continues until the end of file is reached on the customer file, in which case decision 510 branches to “yes” branch 512 and processing terminates at 515.

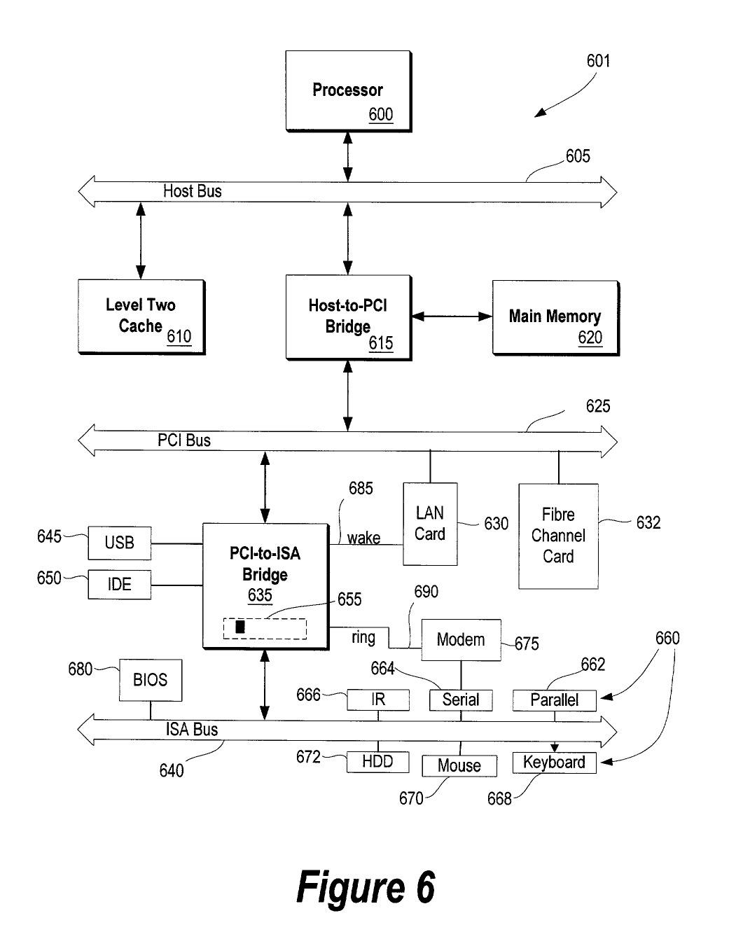

FIG. 6 illustrates information handling system 601 which is a simplified example of a computer system capable of performing the mobile telephone company operations. Computer system 601 includes processor 600 which is coupled to host bus 605. A level two (L2) cache memory 610 is also coupled to the host bus 605. Host-to-PCI bridge 615 is coupled to main memory 620, includes cache memory and main memory control functions, and provides bus control to handle transfers among PCI bus 625, processor 600, L2 cache 610, main memory 620, and host bus 605. PCI bus 625 provides an interface for a variety of devices including, for example, LAN card 630. PCI-to-ISA bridge 635 provides bus control to handle transfers between PCI bus 625 and ISA bus 640, universal serial bus (USB) functionality 645, IDE device functionality 650, power management functionality 655, and can include other functional elements not shown, such as a real-time clock (RTC), DMA control, interrupt support, and system management bus support. Peripheral devices and input/output (I/O) devices can be attached to various interfaces 660 (e.g., parallel interface 662, serial interface 664, infrared (IR) interface 666, keyboard interface 668, mouse interface 670, and fixed disk (HDD) 672) coupled to ISA bus 640. Alternatively, many I/O devices can be accommodated by a super I/O controller (not shown) attached to ISA bus 640.

BIOS 680 is coupled to ISA bus 640, and incorporates the necessary processor executable code for a variety of low-level system functions and system boot functions. BIOS 680 can be stored in any computer readable medium, including magnetic storage media, optical storage media, flash memory, random access memory, read only memory, and communications media conveying signals encoding the instructions (e.g., signals from a network). In order to attach computer system 601 to another computer system to copy files over a network, LAN card 630 is coupled to PCI-to-ISA bridge 635. Similarly, to connect computer system 601 to an ISP to connect to the Internet using a telephone line connection, modem 675 is connected to serial port 664 and PCI-to-ISA Bridge 635.

While the computer system described in FIG. 6 is capable of executing the invention described herein, this computer system is simply one example of a computer system. Those skilled in the art will appreciate that many other computer system designs are capable of performing the copying process described herein.

One of the preferred implementations of the invention is an application, namely, a set of instructions (program code) in a code module which may, for example, be resident in the random access memory of the computer. Until required by the computer, the set of instructions may be stored in another computer memory, for example, on a hard disk drive, or in removable storage such as an optical disk (for eventual use in a CD ROM) or floppy disk (for eventual use in a floppy disk drive), or downloaded via the Internet or other computer network. Thus, the present invention may be implemented as a computer program product for use in a computer. In addition, although the various methods described are conveniently implemented in a general purpose computer selectively activated or reconfigured by software, one of ordinary skill in the art would also recognize that such methods may be carried out in hardware, in firmware, or in more specialized apparatus constructed to perform the required method steps.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. For example, the bank account numbers, etc., may be placed on the preprinted checks differently depending on standards in other countries or based upon a particular situation. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. A method of providing preprinted checks, said method comprising:
receiving customer bank account information;
determining a customer due amount for a customer; and
creating a preprinted check, the preprinted check including the customer bank account information and the customer due amount.

2. The method as described in claim 1 wherein the creating further comprises:
including a merchant account number on the preprinted check, wherein the merchant account number is an account number provided by the merchant that corresponds to the customer.

3. The method as described in claim 3 wherein the merchant account number is printed in a barcode format.

4. The method as described in claim 1 further comprising:
preparing a bill corresponding to the customer; and
sending the bill and the preprinted check to the customer.

5. The method as described in claim 1 further comprising:
printing a merchant name and address on the preprinted check, wherein the merchant name and address are adapted to appear through an envelope window.

6. The method as described in claim 1 wherein the receiving includes receiving at least one of a voided customer check, a customer check, a printed form including a bank routing number and bank account number, and an electronic form including a bank routing number and bank account number.

7. The method as described in claim 1 further comprising:
storing the customer bank account information;
wherein the receiving further includes reading the stored customer bank account information.

8. An information handling system comprising:
one or more processors;
a memory accessible by the processors;
a printer accessible by the processors;
a nonvolatile storage device accessible by the processors; and
a preprinted check tool, the preprinted check tool including:
means for receiving customer bank account information;
means for determining a customer due amount for a customer; and
means for printing a preprinted check on the printer, the preprinted check including the customer bank account information and the customer due amount.

9. The information handling system as described in claim 8 wherein the printing further comprises:
means for including a merchant account number on the preprinted check, wherein the merchant account number is an account number provided by the merchant that corresponds to the customer.

10. The information handling system as described in claim 9 wherein the merchant account number is printed in a barcode format.

11. The information handling system as described in claim 8 further comprising:
means for preparing a bill corresponding to the customer; and
means for sending the bill and the preprinted check to the customer.

12. The information handling system as described in claim 8 further comprising:
means for printing a merchant name and address on the preprinted check, wherein the merchant name and address are adapted to appear through an envelope window.

13. The information handling system as described in claim 8 wherein the means for receiving includes receiving at least one of a voided customer check, a customer check, a printed form including a bank routing number and bank account number, and an electronic form including a bank routing number and bank account number.

14. The information handling system as described in claim 8 wherein the printer includes a magnetic printing capability, and wherein the means for printing further includes means for printing the customer bank account information using the magnetic printing capability.

15. A computer program product for providing preprinted checks, said computer program product comprising:
means for receiving customer bank account information;
means for determining a customer due amount for a customer; and
means for creating a preprinted check, the preprinted check including the customer bank account information and the customer due amount.

16. The computer program product as described in claim 15 wherein the creating further comprises:
means for including a merchant account number on the preprinted check, wherein the merchant account number is an account number provided by the merchant that corresponds to the customer.

17. The computer program product as described in claim 16 wherein the merchant account number is printed in a barcode format.

18. The computer program product as described in claim 15 further comprising:
means for preparing a bill corresponding to the customer; and
means for sending the bill and the preprinted check to the customer.

19. The computer program product as described in claim 15 further comprising:
means for printing a merchant name and address on the preprinted check, wherein the merchant name and address are adapted to appear through an envelope window.

20. The computer program product as described in claim 15 wherein the means for receiving includes means for receiving at least one of a voided customer check, a customer check, a printed form including a bank routing number and bank account number, and an electronic form including a bank routing number and bank account number.
